(19) United States
(12) Patent Application Publication
(10) Pub. No.: US 2005/0175380 A1
(43) Pub. Date: Aug. 11, 2005

(54) Fusing apparatus for electrophotographic image forming system

(75) Inventor: Hwan-guem Kim, Seoul (KR)

Correspondence Address: STAAS & HALSEY LLP, SUITE 700, 1201 NEW YORK AVENUE, N.W., WASHINGTON, DC, 20005, US

(73) Assignee: Samsung Electronic Co., Ltd., Suwon-Si (KR)

(21) Appl. No.: 11/046,781

(22) Filed: Feb. 1, 2005

(30) Foreign Application Priority Data
Feb. 10, 2004 (KR) 2004-8636

(51) Int. Cl. G03G 15/20

(52) U.S. Cl. 399/328

(57) ABSTRACT

A fusing apparatus for an electrophotographic image forming system, including: a fusing roller; a heat roller eccentrically installed in the fusing roller to contact an inner circumferential surface of the fusing roller and which generates heat; and a press roller installed to face and contact the fusing roller so as to bring the print medium, which is passed between the fusing roller and the press roller, into press contact with the fusing roller.

### CROSS-REFERENCE TO RELATED APPLICATION

This application claims the priority of Korean Patent Application No. 2004-08636, filed on, Feb. 10, 2004, in the Korean Intellectual Property Office, the disclosure of which is incorporated herein by reference.

### BACKGROUND OF THE INVENTION

1. Field of the Invention

The present invention relates to an electrophotographic image forming system, and more particularly, to a fusing apparatus for an electrophotographic image forming system, which applies heat and pressure to a toner image to fuse the toner image on print media.

2. Description of Related Art

Generally, an electrophotographic image forming system includes a fusing apparatus, which applies heat and pressure to an image transferred to a printing medium to fuse the image on the printing medium.

FIG. 1 is a cross sectional view of a conventional fusing apparatus 10 using a halogen lamp as a heat source, and FIG. 2 is a longitudinal sectional view showing a relationship between the fusing apparatus 10 of FIG. 1 and a press roller 13.

Referring to FIG. 1, the fusing apparatus 10 includes a fusing roller 11, which has a cylindrical shape, and a heat generator 12 with a halogen lamp installed in the center. A coating layer 11a made of tetrafluoruethylehe is formed on the surface of the fusing roller 11. The heat generator 12 generates heat inside the fusing roller 11, which is heated by a radiant heat transmitted from the heat generator 12.

Referring to FIG. 2, the press roller 13 is positioned below the fusing apparatus 10 such that a print medium 14 is passed between the fusing apparatus 10 and the press roller 13. The press roller 13 is elastically supported by a spring member 13a so as to bring the print medium 14, which is passed between the fusing apparatus 10 and the press roller 13, into press contact with the fusing apparatus 10 to a predetermined pressure.

While the print medium 14 is being passed between the fusing apparatus 10 and the press roller 13, a powdered toner image 14a formed on the print medium 14 is pressurized and heated. That is, the toner image 14a is fused on the print medium 14 by a predetermined pressure and heat that are applied by the fusing apparatus 10 and the press roller 13, respectively.

Above the fusing roller 11, a thermostat 15 and a thermistor 16 are further installed. The thermostat 15 cuts off power supply and prevents overheating when the surface temperature of the fusing roller 11 is abruptly increased. The thermistor 16 measures the surface temperatures of the fusing roller 11 and the coating layer 11a.

The conventional fusing apparatus using the halogen lamp as a heat source, which is mentioned above, results in unnecessary power consumption, so that when there is no print operation (i.e., a printing operation is not being performed), it is required to lower the surface temperature by cutting off power supply. Thereafter, a long warm-up time is required from when the power supply is turned on until the fusing apparatus reaches the temperature required for fusing operation.

The time required from when power supply is turned on until a fusing apparatus reaches a desired temperature for fusing operation is referred to as a first-print-out-time (FPOT). Typically, a conventional fusing apparatus requires an FPOT of several tens seconds to several minutes.

Also, in the conventional fusing apparatus, since the fusing roller is heated due to a radiant heat from a heat source, a heat transmission rate is low. Also, as the fusing roller is in contact with a print medium and transmits heat to the print medium, it takes a long time to compensate for a temperature deviation resulting from a drop in temperature. As a result, controlling temperature dispersion is difficult.

Further, even when a standby mode in which print operation is stopped, since power should be still supplied to the heat source in regular time intervals in order to maintain the fusing roller at a constant temperature, unnecessary power consumption is incurred. Also, a long time is required to convert the standby mode into an operating mode for outputting an image, thereby delaying outputting of the image.

To solve these problems, a direct-heating-type fusing apparatus, which directly transmits heat from a heat roller to a print medium and fuses an image to the print medium, is disclosed in Japanese Patent Laid-open Publication No. 6-110348.

This fusing apparatus of the '348 patent document can raise the temperature of a press roller in a short amount of time so that the FPOT can be remarkably shortened. However, since a heat generator comes into contact with a print medium, the heat generator may break. In addition, an insulating layer may be damaged by a release device of releasing a print medium from the fusing apparatus, and thus there are possibilities of occurrences of fires or electric shocks.

### BRIEF SUMMARY

An aspect of the present invention provides a fusing apparatus, which can heat a fusing roller to a temperature required for fusing operation in a short amount of time and reduce warm-up time.

According to an aspect of the present invention, there is provided a fusing apparatus for an electrophotographic image forming system, including: a fusing roller; a heat roller eccentrically installed in the fusing roller to contact an inner circumferential surface of the fusing roller and which generates heat; and a press roller installed to face and contact the fusing roller so as to bring the print medium, which is passed between the fusing roller and the press roller, into press contact with the fusing roller.

According to another aspect of the present invention, there is provided an electrophotographic image forming apparatus, including: a fusing apparatus having a heat roller which generates heat, and a fusing roller which comes into contact with the heat roller, transmits the heat, and rotates about a first axis, wherein the heat roller is disposed in the fusing roller and rotates about a second axis eccentrically positioned from the first axis.

According to another aspect of the present invention, there is provided an electrophotographic image forming method, including: generating heat via a heating roller; transmitting the heat via a fusing roller which comes into contact with the heat roller and which rotates about a first axis, wherein the heat roller is disposed in the fusing roller and rotates about a second axis eccentrically positioned from the first axis.

According to another aspect of the present invention, there is provided a method of improving the fusing of an electrophotographic image, including: generating heat via a heating roller having a heating layer which generates heat and which has a uniform thickness; transmitting the heat via a fusing roller which comes into contact with the heat roller and which rotates about a first axis, wherein the heat roller is disposed in the fusing roller and rotates about a second axis eccentrically positioned from the first axis.

Additional and/or other aspects and advantages of the present invention will be set forth in part in the description which follows and, in part, will be obvious from the description, or may be learned by practice of the invention.

### BRIEF DESCRIPTION OF THE DRAWINGS

These and/or other aspects and advantages of the present invention will become apparent and more readily appreciated from the following detailed description, taken in conjunction with the accompanying drawings of which:

FIG. 1 is a cross sectional view of a conventional fusing apparatus using a halogen lamp as a heat source;

FIG. 2 is a longitudinal sectional view showing a relationship between the fusing apparatus of FIG. 1 and a press roller;

FIG. 3 is a longitudinal sectional view of a fusing apparatus according to an embodiment of the present invention;

FIG. 4 is a cross sectional view of the fusing apparatus of FIG. 3;

FIG. 5 is a front view of a heat generating layer provided on the outer circumferential surface of a heat roller of the fusing apparatus of FIG. 3; and

FIG. 6 is a graph showing an increase in temperature over time of the fusing apparatus of FIGS. 3-5 in comparison with the conventional apparatus of FIGS. 1 and 2.

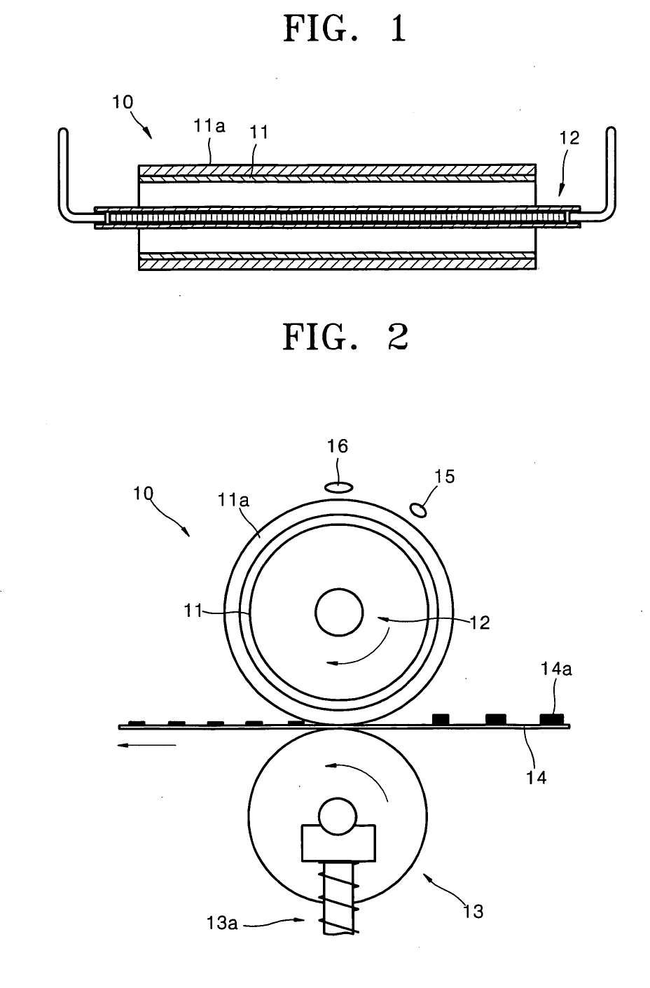

### DETAILED DESCRIPTION OF EMBODIMENT

Reference will now be made in detail to an embodiment of the present invention, examples of which are illustrated in the accompanying drawings, wherein like reference numerals refer to the like elements throughout. The embodiment is described below in order to explain the present invention by referring to the figures.

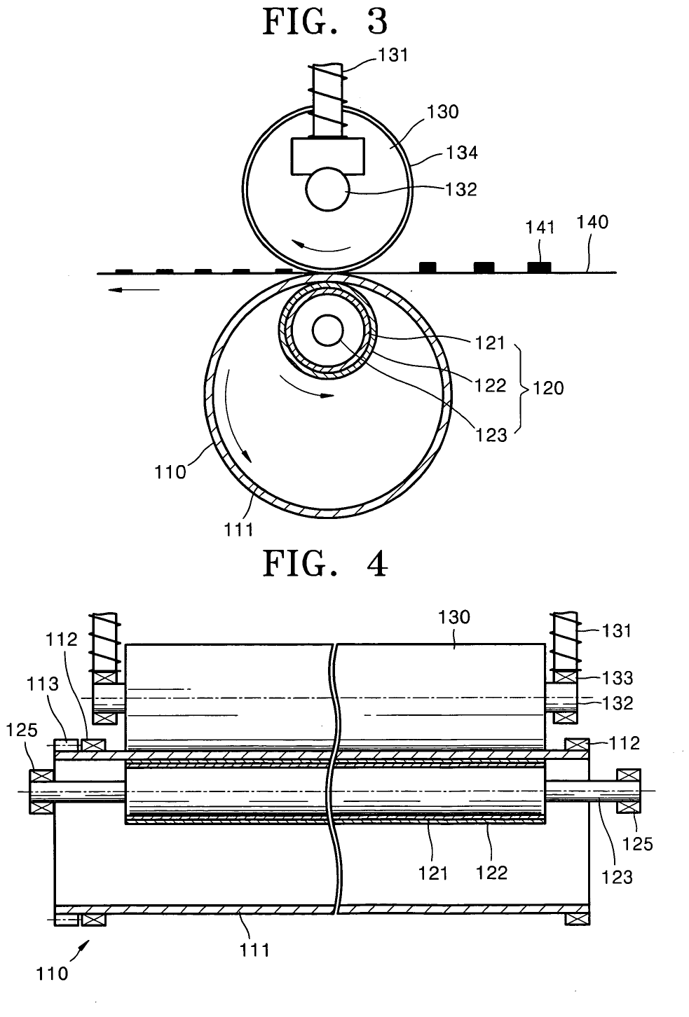

Referring to FIGS. 3 and 4, which show a fusing apparatus 100 according to an embodiment of the present invention, the fusing apparatus 100 applies heat and pressure to a toner image 141 transferred to a print medium 140 and fuses the toner image 141 on the print medium 140. The fusing apparatus 100 includes a fusing roller 110 and a press roller 130. The fusing roller 110 is installed to rotate in the directions of the arrows and applies heat to the toner image 141. The press roller 130 is installed to face the fusing roller 110 so as to bring the print medium 140, which is passed between the fusing roller 110 and the press roller 130, into press contact with the fusing roller 110.

The fusing roller 110 has a cylindrical shape and includes a release layer 111 coated with tetrafluoruethylene on the outer circumferential surface thereof. Both ends of the fusing roller 110 are rotatably supported by bearings 112, and a drive mechanism 113 is disposed at one side of the fusing roller 110. The drive mechanism 113 may be interlocked with a gear prepared therein and obtains power from the outside.

The fusing roller 110 may have a thickness of about 0.3 to 0.5 mm.

Inside the fusing roller 110, a heat roller 120, which transmits heat through the fusing roller 110 to the toner image 141 transferred to the print medium 140, is installed.

The heat roller 120 includes a heat generating layer 121 having a cylindrical shape and a protective layer 122. The heat generating layer 121 is installed so as to enclose the outer circumferential surface of the heat roller 120, and the protective layer 122 is installed so as to enclose the heat generating layer 121 and to cut off (i.e., insulate) electric flow.

The central rotation axis 123 of the heat roller 120 is eccentrically positioned from an axial line of the fusing roller 110 toward the inner circumferential surface of the heat roller 120. Both ends of the heat roller 120 are supported by supporters 125 such that the heat roller 120 is rotatably in contact with the inner circumferential surface of the fusing roller 110. The supporters 125 are positioned outside of the fusing roller 110.

As the fusing roller 110 rotates, the heat roller 120 comes into contact with the inner circumferential surface of the fusing roller 110 and is passively rotated, thereby transmitting heat from the heat generating layer 121 to the fusing roller 110.

The following is a description of a process of forming the heat generating layer 121. First, a paste is made by mixing Ru-based oxide, PbO-based glass, an organic binder, a solvent, and an additive and coated on the outer circumferential surface of the heat roller 120 to a uniform thickness using a screen print method. After the paste is dried, an insulating layer is coated thereon and sintered to a temperature of about 550° C. Thus, the heat generating layer 121 is completed.

The Ru-based oxide determines the electric characteristics of the heat generating layer 121, and the glass binder disperses conductive materials and inorganic binders.

The average diameter of grains of Ru-based power may be in the range of 0.01 to 0.1 μm. When the average diameter of grains of Ru-based power is less than 0.01 μm, grains are too fine to achieve good sinterability, while when the average diameter thereof is more than 0.1 μm, it is difficult to form a uniformly thick layer.

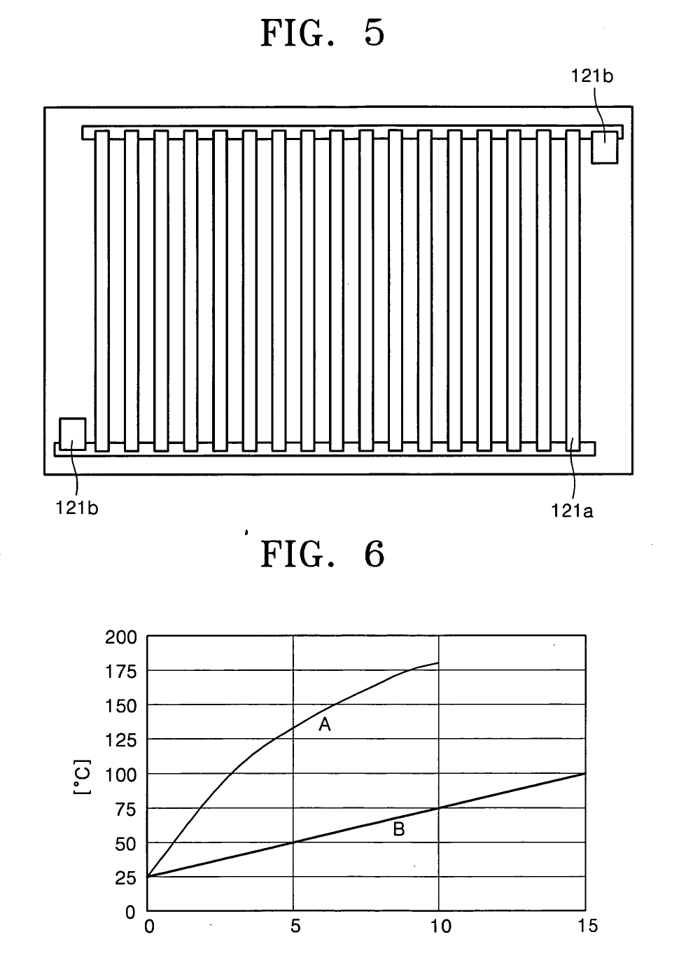

As shown in FIG. 5, which is a front view of the heat generating layer 121, the heat generating layer 121 is formed of heat generators 121a arranged in predetermined intervals. The heat generators 121a are each connected to electrodes 121b formed at both ends of the heat generating layer 121 and receive current from the outside. Although a conducting path is not shown in the figures, it is to be understood that the current can be transmitted from the outside by a known method.

The protective layer 122 may be formed of a perfluoroalkoxy (PFA) tube. The heat generating layer 121 is inserted into the protective layer 122, and then thermal treatment is performed at a temperature of about 330° C. or higher to shrink the protective layer 122.

The protective layer 122 prevents current from flowing to the outside to insulate the heat generating layer 121 from the fusing roller 110.

The press roller 130, which is supported by support members 133, rotates on a central axis 132, which is elastically biased toward the fusing roller 110 due to elastic members 131, and brings the print medium 140 into press contact with the fusing roller 110.

Also, a PFA coating layer 134 is formed on the outer circumferential surface of the press roller 130 to prevent contamination of a toner or the like.

FIG. 6 illustrates the results of an experiment where the fusing apparatus of the present embodiment and the conventional apparatus were each heated from a room temperature to a temperature required for fusing operation.

Referring to FIG. 6, curve A shows an increase in temperature over time in case of the fusing apparatus according to the present embodiment, while curve B shows an increase in temperature over time in case of the conventional apparatus.

Curve A was obtained using a press roller having a diameter of 40 mm and formed of sponge, a fusing roller having a diameter of 40 mm, a heat roller having a diameter of 25 mm and which supplied a power of 1200 W, a nip between the press roller and fusing roller of 5 mm, and rotating the press roller and the fusing roller at a rate of 50 ppm without using print media.

Curve B was obtained using a press roller having a diameter of 40 mm and formed of sponge, a fusing roller having a diameter of 40 mm, a halogen lamp heat generator that supplied a power of 1650 W, a nip between the press roller and the fusing roller of 5 mm, and rotating the press roller and the fusing roller at a rate of 50 ppm without using print media.

As shown in FIG. 6, it took about 10 seconds to heat the fusing apparatus according to the present embodiment from a normal temperature (25° C.) to a temperature required for fusing operation (175° C.), whereas it took about 15 seconds or more to heat the conventional apparatus. In other words, the fusing apparatus of the present embodiment was heated to about 15° C. per second, but the conventional apparatus was heated to about 5.9° C. per second. Accordingly, the fusing apparatus of the present embodiment can shorten the warm-up time more effectively in comparison with the conventional apparatus.

As described above, the disclosed fusing apparatus for the electrophotographic image forming system has the following advantages. Initially, a fusing roller can reach a temperature required for fusing operation in a short amount of time, thereby shortening the warm-up time. Also, a heat generating layer is produced to a uniform thickness so that the fusing roller can maintain a uniform temperature distribution. As a result, the fusing characteristic of the fusing roller is improved. Further, heat generated by a heat roller is transmitted to a print medium through the fusing roller, thereby preventing damage of the print medium.

Although an embodiment of the present invention has been shown and described, the present invention is not limited to the described embodiment. Instead, it would be appreciated by those skilled in the art that changes may be made to the described embodiment without departing from the principles and spirit of the invention, the scope of which is defined by the claims and their equivalents.

1. A fusing apparatus for an electrophotographic image forming system, comprising:
a fusing roller;
a heat roller eccentrically installed in the fusing roller to comeinto contact an inner circumferential surface of the fusing roller and which generates heat; and
a press roller installed to face and contact the fusing roller so as to bring the print medium, which is passed between the fusing roller and the press roller, into press contact with the fusing roller.

2. The apparatus of claim 1, wherein the heat roller includes:
a heat generating layer which coats an outer circumferential surface of the heat roller and generates heat; and
a protective layer which wraps the heat generating layer and insulates the heat generating layer from fusing roller,
wherein, as the fusing roller rotates, the heat roller comes into contact with the inner circumferential surface of the fusing roller and is rotated so as to transmit the heat from the heat generating layer to the fusing roller.

3. The apparatus of claim 2, Wherein the heat roller has a rotation axis, which is installed eccentrically from a central axial line of the fusing roller toward the inner circumferential surface of the fusing roller inside the fusing roller.

4. The apparatus of claim 1, wherein the heat roller has a rotation axis, which is eccentric from a central axial line of the fusing roller toward the inner circumferential surface of the fusing roller inside the fusing roller.

5. The apparatus of claim 1, wherein the fusing roller has a thickness of about 0.3 to 0.5 mm.

6. An electrophotographic image forming apparatus, comprising:
a fusing apparatus including
a heat roller which generates heat, and
a fusing roller which comes into contact with the heat roller, transmits the heat, and rotates about a first axis,
wherein the heat roller is disposed in the fusing roller and rotates about a second axis eccentrically positioned from the first axis.

7. The apparatus of claim 6, further comprising a press roller facing the fusing roller and pressing print media passing between the fusing roller and the press roller into press contact with the fusing roller.

8. The apparatus of claim 7, wherein the press roller is biased toward the fusing roller.

9. The apparatus of claim 7, wherein the press roller includes a protective layer on an outer circumferential surface thereof.

10. The apparatus of claim 6, wherein the fusing roller includes a release layer.

11. The apparatus of claim 10, wherein the release layer includes tetrafluouethlylene.

12. The apparatus of claim 6, wherein the heat roller includes a heat generating layer and a protective layer enclosing the heat generating layer.

13. The apparatus of claim 12, wherein the protective layer electrically insulates the heat generating layer.

14. The apparatus of claim 12, wherein the protective layer is a perfluoroalkoxy tube.

15. An electrophotographic image forming method, comprising:
generating heat via a heating roller;
transmitting the heat via a fusing roller which comes into contact with the heat roller and which rotates about a first axis,
wherein the heat roller is disposed in the fusing roller and rotates about a second axis eccentrically positioned from the first axis.

16. A method of improving the fusing of an electrophotographic image, comprising:
generating heat via a heating roller having a heating layer which generates heat and which has a uniform thickness;
transmitting the heat via a fusing roller which comes into contact with the heat roller and which rotates about a first axis,
wherein the heat roller is disposed in the fusing roller and rotates about a second axis eccentrically positioned from the first axis.
